(19) United States
(12) Patent Application Publication
(10) Pub. No.: US 2026/0244421 A1
(43) Pub. Date: Aug. 20, 2026

(54) AIRCRAFT SERVER CONTAINERIZATION

(71) Applicant: Viasat Inc., Carlsbad, CA (US)

(72) Inventors: Donald R. BUCHMAN, San Diego, CA (US); Zeeshan BURHANI, Carlsbad, CA (US)

(21) Appl. No.: 19/475,316

(22) PCT Filed: Apr. 17, 2023
(86) PCT No.: PCT/US2023/018837

§ 371 Date: Oct. 14, 2025

(51) Int. Cl. G06F 8/60; H04W 4/42; H04W 4/50

(52) U.S. Cl. CPC G06F 8/60; H04W 4/42; H04W 4/50

(57) ABSTRACT

Methods, systems, and devices for aircraft server containerization are described. A server on a mobile platform may implement a containerization engine to provision containers of server resources for applications executed by the server. For example, a central node of a ground-based terminal of a communication network may distribute an application to a server, and the server may 2024/220069 provision a container containing an amount of resources to be used by the application. In some examples, a size of the container may be selected, for example by a developer of the application. In some examples, the central node may include a development environment which may be provided to developers. The development environment may allow developers to model resources on mobile platforms and may provide an application programming interface for developers to develop applications for a server.

### CROSS REFERENCE

The present Application is a 371 national phase filing of International Patent Application No. PCT/US2023/018837 by BUCHMAN et al. entitled, “AIRCRAFT SERVER CONTAINERIZATION,” filed Apr. 17, 2023, which is assigned to the assignee hereof and is hereby incorporated by reference in its entirety.

### BACKGROUND

The following relates generally to communications, including aircraft server containerization.

An aircraft may include a two-way communication system to provide network access (e.g., to the Internet) to passengers and other aircraft functions. The aircraft may also include a server to support the communication system, support connectivity, support user experience, and support aircraft operations (e.g., flight data logging). However, the server may have idle resources a substantial amount of time for operations of the aircraft.

### SUMMARY

The described techniques relate to improved methods, systems, devices, and apparatuses that support aircraft server containerization. For example, a method is described. The method may include providing a containerization engine on a mobile platform which includes a server coupled with a communication network. The containerization engine may be associated with an application programming interface that supports a request associated with a hardware resource of the mobile platforms. A central node of the communication network may receive an application associated with the application programming interface, and the server may provision a container associated with resources for the application. The communications network may distribute the application to the server mobile platform.

### BRIEF DESCRIPTION OF THE DRAWINGS

FIG. 1 illustrates an example of a satellite communication system that supports aircraft server containerization in accordance with examples described herein.

FIG. 2 illustrates an example of a system that supports aircraft server containerization in accordance with examples described herein.

FIG. 3 illustrates an example of a system that supports aircraft server containerization in accordance with aspects of the present disclosure.

FIG. 4 shows a block diagram of a beam manager that supports aircraft server containerization in accordance with aspects of the present disclosure.

FIG. 5 shows a diagram of a system including a device that supports aircraft server containerization in accordance with aspects of the present disclosure.

FIG. 6 shows a flowchart illustrating methods that support aircraft server containerization in accordance with aspects of the present disclosure.

### DETAILED DESCRIPTION

Some satellite communication systems may include one or more mobile platforms (e.g., aircraft) which may have a mobile terminal that communicates with a central node via a satellite of the system. Each mobile platform may include a respective server, which may support the support the communication system (e.g., by supporting access to a network for user devices on the mobile platform). Additionally, a server may have access to environmental factors of the mobile platform, such as altitude, flight speed, temperature, weather, wind conditions, or any combination thereof. The server may have idle resources a substantial amount of time of operations of the mobile platform. However, use of the computing resources of the server on the mobile platform may provide challenges due to security concerns and concerns of exceeding limited computing resources (e.g., a server may have a finite quantity of storage space, processing time, bandwidth for network communication).

As described herein, a server on a mobile platform may implement a containerization engine to provision containers of server resources for applications executed by the server. For example, a central node of a ground network of a communication network may distribute an application to a server on a mobile platform, and the server may provision a container configured for operation according to an amount of resources to be used by the application. In some examples, a “size” of the container (e.g., an amount of resources associated with the container) may be selected, for example by a developer of the application, such that an application with relatively high importance or relatively high resource usage may make use of a higher amount of resources than an application with a relatively low importance or resource usage. In some examples, the central node may include a development environment which may be provided to developers. The development environment may allow developers to model resources on mobile platforms and may provide an application programming interface for developers to develop applications for servers on mobile platforms.

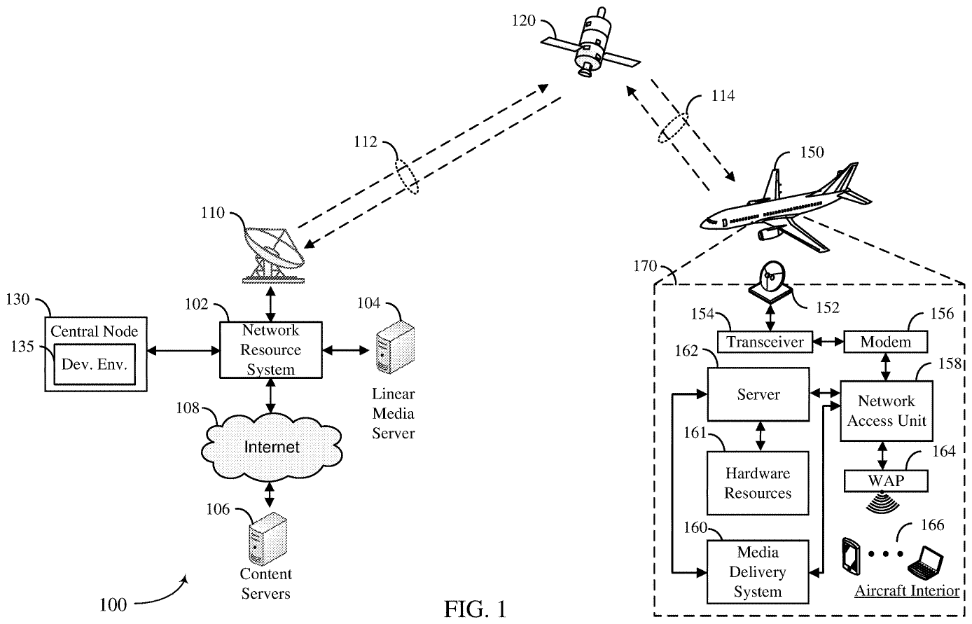

Aspects of the disclosure are initially described in the context of satellite communication systems with reference to FIG. 1. Aspects of the disclosure are further illustrated by and described with reference to apparatus diagrams, system diagrams, block diagrams, and flowcharts that relate to aircraft server containerization.

FIG. 1 shows an example of a satellite communication system 100 that supports aircraft server containerization in accordance with examples described herein. Satellite communication system 100 may include a satellite 120 in bidirectional communication with a ground terminal 110 via a feeder communication link 112. In some cases, ground terminal 110 may be known as an access node or a gateway. Satellite 120 may also be in bidirectional communication with a mobile platform 150 via a service communication link 114.

Accordingly, feeder communication link 112 and service communication link 114 may enable communication between mobile platform 150 and ground terminal 110 via satellite 120 while mobile platform 150 is stationary or in motion. Although a single ground terminal 110 is shown to avoid over complication of the drawing, the satellite communication system 100 may include many more ground terminals.

Ground terminal 110 may be in communication with a network resource system 102. Networks or communication links between ground terminal 110 and network resource system 102 may be any type of network and may include for example, the Internet, an IP network, an intranet, a wide area network (WAN), local area network (LAN), a virtual private network (VPN), a virtual LAN (VLAN), a fiber optic network, a cable network, a public switched telephone network (PSTN), a public switched data network (PSDN), a public land mobile network, a cellular network, and/or any other type of network supporting communication as described herein.

In some examples, network resource system 102 may be in communication with a linear media server 104. Although FIG. 1 shows a single linear media server 104, the present application is not so limited and a plurality of linear media servers are also contemplated. Networks or communication links between network resource system 102 and linear media server 104 may be any type of network and may include for example, the Internet, an IP network, an intranet, a wide area network (WAN), local area network (LAN), a virtual private network (VPN), a virtual LAN (VLAN), a fiber optic network, a cable network, a public switched telephone network (PSTN), a public switched data network (PSDN), a public land mobile network (PLMN), a cellular network, and/or any other type of network supporting communication as described herein.

Linear media server 104 may include one or more media servers, media storage devices, as well as other data stores. The linear media server 104 may for example be a cable television headend, satellite television headend, network bitstream of linear content, or any combination thereof. Linear media server 104 may be configured to provide linear media channels to network resource system 102. Linear media data generally refers to any stream of content that is scheduled for delivery at a certain time (e.g., a television show run at a set time, a live event, a televised sporting event, etc.). For example, various broadcast television channel offerings may be available from linear media server 104 and may be referred to as linear media channel data. Thus, when a user decides to select, for example, a “channel” carrying linear media content, the user effectively elects to consume whatever scheduled media is playing on that channel at that time; as opposed to directly selecting the media content item itself and initiating the media content item to begin playing at the beginning.

In some examples, network resource system 102 is also in communication with content server 106 via Internet 108 and/or other type of network. Although FIG. 1 shows a single content server 106, the present application is not so limited and a plurality of content servers are also contemplated. Content server 106 may include one or more servers, storage devices, etc., as well as other data stores. Content server 106 may be configured to provide network data to network resource system 102 in response to requests originating from passengers on mobile platform 150 (discussed in more detail below). Network data generally refers to requested on-demand content, for example Internet page content, YouTube or other audio and/or video content that is available for viewing from a user-selectable part of the content on-demand, text messaging, email messaging, other streaming data, and web browsing by the passengers on mobile platform 150.

As will be described in more detail below, network resource system 102 may be configured to schedule transmission of packets of the linear media channel data received from linear media server 104 and packets of the network content received from content server 106 to mobile platform 150 via ground terminal 110, feeder communication link 112, satellite 120 and service communication link 114 based at least in part on a congestion status of one or both of feeder communication link 112 and service communication link 114. The functions of the network resource system 102 may be implemented in hardware, instructions embodied in a memory and formatted to be executed by one or more general or application-specific processors, firmware, and any combination thereof.

In some examples, the network resource system may be in communication with a central node 130. The central node 130 may an example of a system or device configured to manage applications or other programs generated by third parties to be executed on servers 162 of mobile platforms 150. For example, the central node 130 may manage applications which allow access to media (e.g., media stored on the linear media server 104, media stored on content servers 106), applications which provide entertainment or information to users, applications used by operators of a mobile platform 150 to analyze metrics such as mobile platform resources, environmental factors, or fuel usage, or may manage other applications.

The central node 130 may receive an application, for example an application submitted by a third party, and distribute the application to one or more mobile platforms 150, for example via the ground terminal 110. In some examples, the mobile platforms 150 to which the application is distributed may be selected by a third party developer of the application, or may be determined by the central node 130. The central node 130 may also distribute (e.g., via the ground terminal 110) updates for the application to the one or more mobile platforms 150. In some cases, the central node 130 may distribute updates according to an update period for the application. For example, the third party developer of the application may select an update period, such as daily updates, weekly updates, monthly updates, and so on. The third party developer may provide the updates to the central node 130, and the central node 130 may distribute the updates according to the selected update period.

In some examples, the central node 130 may include or may support a development environment 135. The development environment 135 may be an example of software used in the development of applications managed by the central node 130. For example, the development environment 135 may include a software development kit (SDK), which may allow for development of applications to be executed on one or more mobile platforms 150. In some examples, the development environment 135 may also include an application programming interface (API), which may be associated with the SDK. For example, the SDK may include or may facilitate access to one or more libraries used by the API. The central node 130 may provide the development environment 135 to third parties, and may receive applications developed using the development environment 135.

While a single mobile platform 150 (in this example, an airplane) is shown in communication via a single satellite 120 in FIG. 1, the techniques described herein can be applied in many other communication environments. For example, mobile platforms capable of participating in the satellite communication system 100 shown in FIG. 1 may include: aircraft (e.g., airplanes, helicopters, blimps, balloons, etc.), trains, automobiles (e.g., cars, trucks, busses, etc.), watercraft (e.g., private boats, commercial shipping vessels, cruise ships, etc.) and others. Any or all such mobile platforms may communicate via any one or more suitable communication system(s), including any suitable communication links, such as: a satellite communication system, an air-to-ground communication system, a hybrid satellite and air-to-ground communication system, a cellular communication system, and others.

Mobile platform 150 may include a two-way communication system 170 (e.g., including aspects of a mobile terminal) to facilitate bidirectional communication with satellite 120 via service communication link 114. Two-way communication system 170 may receive a forward link signal from satellite 120 and transmit a return link signal to satellite 120 via service communication link 114.

In the example depicted by FIG. 1, two-way communication system 170 may include an antenna system 152 in communication with a transceiver 154, a modem 156 in communication with transceiver 154, a network access unit 158 in communication with modem 156, a wireless access point 164 in communication with network access unit 158, one or more client devices 166 in wireless communication with wireless access point 164, a media delivery system 160 in communication with network access unit 158, and a server 162. In some cases, the two-way communication system 170 may also include one or more client devices in communication with media delivery system 160.

The server 162 may be an example of a computing device operable to execute applications and deliver content to the one or more client devices 166 (e.g., via the network access unit 158). The server 162 may receive applications distributed from the central node 130 and execute the applications using a set of server resources. Server resources may include resources such as storage space on the server 162 (e.g., non-volatile storage space associated with storing software and other digital components of the application, volatile storage space associated with executing the application), access to a processor of the server 162 (e.g., an amount of processing time used by the application), data communicated over a network, such as data transmitted to the ground terminal 110 via a satellite 120, or data communicated between mobile platforms 150, access to hardware resources 161 of the mobile platform (e.g., a bus of the mobile platform 150 which may provide information related to operational events of the mobile platform 150), or any combination thereof. For example, on aircraft hardware resources 161 may include a data bus of the mobile platform 150 which operates according to an aeronautical radio incorporated (ARINC) protocol.

The server 162 may provision one or more containers of resources for applications received from the central node 130. For example, each application may be associated with a corresponding container, and an application may have access to the resources associated with the corresponding container. In some cases, the amount of resources available to an application (e.g., the amount of resources of the container in which the application is run) may be selected or determined by a third party developer of the application. For example, a third party developer may interact with central node 130 to purchase use of the amount of resources of the server 162 for the application.

The amount and type of resources within a container may vary depending on the associated application. For example, an application which uses a large amount of storage space, such as an application to access in-flight entertainment stored on the server 162, may make use of a container having a larger amount of storage resources. An application which communicates with a ground-based network or other mobile platforms, such as an application to access the Internet or an application to crowd-source data with near-by aircraft, may make use of a container having a larger amount of communication resources. An application which is computation heavy, such as an application to optimize fuel usage or calculate flight paths, may make use of a container having more access to a central processing unit of the server 162. Additionally, such an application may make use of hardware resources (e.g., access to mobile platform parameters, such as flight speed, altitude, wind measurements, temperature measurements), and accordingly may make use of a container having access to a data bus associated with operational events of the mobile platform. To facilitate flexibility and efficient distribution of the resources of the server 162, containers of the server 162 may be associated with various amounts of resources (e.g., the server 162 may include containers of different “sizes”, where a size of a container corresponds to an amount of resources associated with the container).

Client devices 166 may include fixed or on-craft devices, such as passenger seat-back systems or other devices on mobile platform 150. Client devices 166 may communicate with media delivery system 160 via a communication link that may be wired or wireless, for example, as part of a local area network such as a wireless local area network (WLAN). Client devices 166 may execute one or more applications that provide an interface for users on the mobile platform 150 to obtain and consume linear media channels, as previously described. The user may have the option to select/request one or more linear media channels from the interface. When a user selects a particular linear media channel for consumption, client devices 166 may transmit a request for the selected linear media channel to media delivery system 160.

Media delivery system 160 may be configured to receive the request for the selected linear media channel from client devices 166 and forward the request to network access unit 158. Media delivery system 160 can provide for on-board media distribution and can include one or more media servers, media storage devices, or both. Media delivery system 160 can broker distribution of linear media channels, by managing requests for the channels from the client devices 166, and distributing the channels to the client devices 166 according to the requests. The functions of media delivery system 160 can be implemented in hardware, instructions embodied in memory and formatted to be executed by one or more general or application-specific processors, firmware, or any combination thereof. In the illustrated embodiment, the media delivery system 160 is shown as a separate component. In alternative embodiments, some or all of the functionality of the media delivery system 160 may be integrated into the network access unit 158 or the server 162 (e.g., as an application running in a container on server 162).

Client devices 166 may include personal client devices configured to receive and display network data and that may be brought onto mobile platform 150 by passengers (e.g., mobile phones, tablets, laptop computers, etc.). Client devices 166 may execute one or more applications that provide an interface for users to obtain and consume network data, as previously described. The user may have the option to request (e.g., select) network content for viewing from the interface. When a user interacts with client devices 166, the client devices 166 may transmit a request for the selected network content to a network access unit 158 via wireless access point 164. Client devices 166 are also configured to receive the requested network content from the network access unit 158 via wireless access point 164.

Wireless access point 164 is configured to provide communication between network access unit 158 and client devices 166.

Network access unit 158 may be configured to receive the request(s) for the selected linear media channel(s) from media delivery system 160 and multiplex and forward them to modem 156. Network access unit 158 may also be configured to receive and demultiplex linear media channel packets associated with the selected linear media channel from modem 156 and forward them to media delivery system 160.

Network access unit 158 may further be configured to receive the requests for the selected network content from client devices 166 via wireless access point 164 and multiplex and forward them to modem 156. Network access unit 158 may also be configured to receive and demultiplex network traffic packets associated with the selected network content and forward them to client devices 166 via wireless access point 164.

Modem 156 may receive the previously described requests, indications and any other data from client network access unit 158 and generate modulated data (e.g., generate a baseband or intermediate frequency (IF) transmit signal) for delivery to transceiver 154. Modem 156 may additionally receive the requested linear media channel data and requested network data as modulated data (e.g., a baseband or IF receive signal) from transceiver 154 and demodulate that data for transmission to network access unit 158. In some embodiments, the modem 156 may be integrated with the network access unit 158, while in others modem 156 may be a separate component.

Transceiver 154 may up-convert and amplify the modulated data received from modem 156 to generate a return link signal of the service communication link 114 for transmission to satellite 120 via antenna system 152. Similarly, transceiver 154 may receive the forward link signal of the service communication link 114 from satellite 120 via antenna system 152. Transceiver 154 may then amplify and down-convert the forward link signal to generate modulated downlink data (e.g., a baseband or IF receive signal) for demodulation by the modem 156.

Although the above description details certain client devices 166 communicating with media delivery system 160 to request and receive linear media channels, and other client devices 166 communicating with the network access unit 158 to request and receive network data, the present application also contemplates that client devices 166 could also request and receive network data, and that client devices 166 could also request and receive linear media channel data. In such embodiments, each of media delivery system 160 and network access unit 158 may further include functionality of the other as previously described in order to support such requesting and receiving configurations of client devices 166. The functions of each of media delivery system 160 and network access unit 158 can be implemented in hardware, instructions embodied in a memory and formatted to be executed by one or more general or application-specific processors, firmware, or any combination thereof.

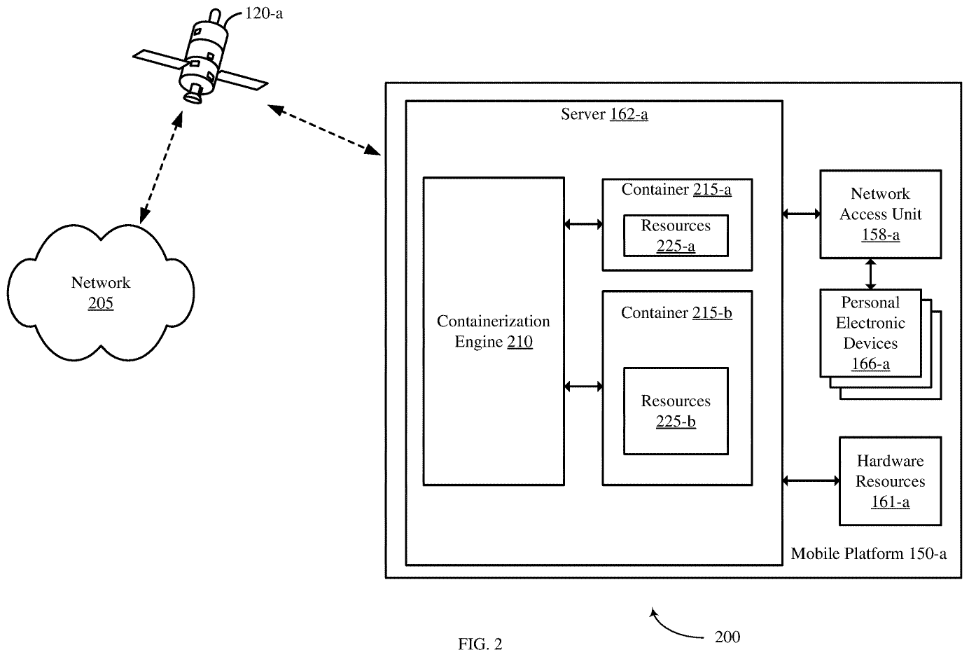

FIG. 2 illustrates an example of a system 200 that supports aircraft server containerization in accordance with aspects of the present disclosure. The system 200 may include a server 162-a within a mobile platform 150-a, which may be examples of the server 162 and the mobile platform 150 as described with referenced to FIG. 1. While shown as a single physical computing device in FIG. 2, in some aspects, one or more of the functions discussed below with respect to the server 162-a may be performed by different physical computing devices. Moreover, the functionalities described herein may be distributed among the components in a different manner than described herein. In some examples, the server 162-a may be in communication with a network access unit 158-a, which may provide gateway functionality between one or more client devices 166-a on the mobile platform 150-a and the networks discussed above with respect to FIG. 1.

Consistent with FIG. 1, the network access unit 158-a may be in communication, via satellite 120-a (or other suitable communications network, as described above), with a terrestrial based network 205. The terrestrial based network may include a ground terminal 110, a network resource system 102, a linear media server 104, and a central node 130, as described with reference to FIG. 1. Further, the terrestrial based network 205 may be in communication with a content server 106 (e.g., via Internet 108). The network access unit 158-a may also be in communication with personal electronic devices 166-a, which may be examples of the client devices 166 as described with reference to FIG. 1.

The server 162-a may be an example of a computing device operable to execute applications and deliver content to the one or more personal electronic devices 166-a (e.g., via the network access unit 158-a). The server 162-a may receive applications distributed from the network 205 (e.g., from the central node 130 of the network 205) and execute the applications using a set of server resources. Server resources may include resources such as storage space on the server 162-a (e.g., non-volatile storage space associated with storing software and other digital components of the application, volatile storage space associated with executing the application), access to a portion of a capacity of a central processing unit of the server 162-a, data communicated to the network 205 (e.g., via the satellite 120-a), or data communicated between different mobile platforms 150-a, access to hardware resources 161-a of the mobile platform 150-a which may provide information related to operational events of the mobile platform 150-a (e.g., a data bus of the mobile platform 150 which operates according to an ARINC protocol), or any combination thereof.

The server 162-a may include a containerization engine 210, which may provision one or more containers, such as a container 215-a and a container 215-b, with resources 225-a and resources 225-b, respectively, for applications received from the network 205. For example, an application may be associated with the container 215-a, which may accordingly have access to the resources 225-a. In some cases, the amount of the resources 225-a may be selected or determined by a third party developer of the application. For example, a second application associated with the container 215-b may use a higher amount of resources (e.g., more storage space, more network communication, more processing time) compared to the application associated with the container 215-a. Accordingly, a developer of the second application may select (e.g., request, purchase) a higher amount of resources 225-b to be provisioned to the container 215-b compared with the resources 225-a provisioned to the container 215-a to support the second application.

In some examples, the server 162-a may support an API, an SDK, or both associated with the development environment 135. For example, the server 162-a may include one or more libraries of software associated with the API and the SDK. Accordingly, applications executed by the server 162-a may utilize aspects of the API and SDK. In some cases, as part of provisioning the container 215-a and the container 215-b, the containerization engine 210 may link the one or more libraries, or a portion or more libraries, with the resources 225-a and the resources 225-b (e.g., linking the libraries to the respective applications associated with the container 215-a and the container 215-b as part of compiling the respective applications). Further, the containerization engine 210 may link additional libraries (e.g., libraries not associated with the API or the SDK) with the resources 225-a and 225-b, such as other libraries used by the respective application.

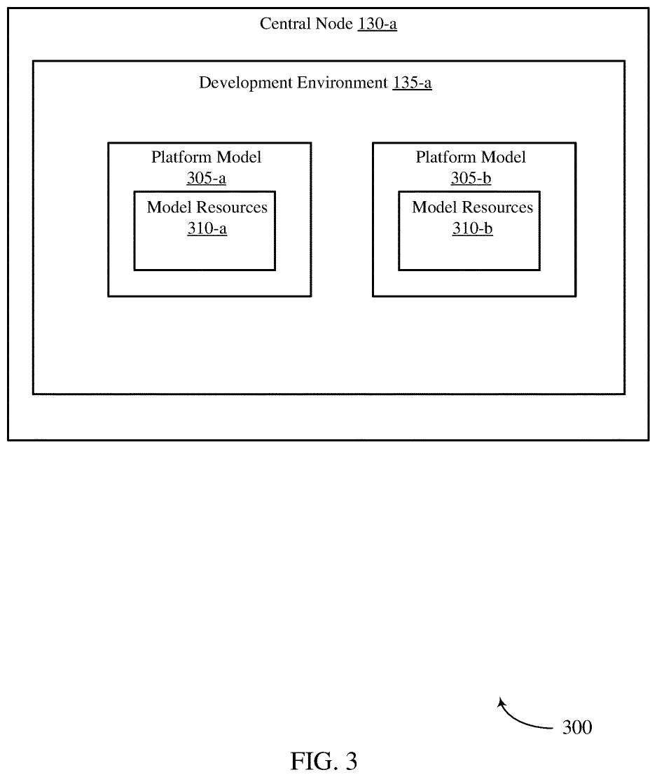

FIG. 3 illustrates an example of a system 300 that supports aircraft server containerization in accordance with aspects of the present disclosure. The system 300 may include a central node 130-a, which may be an example of the central node 130 as described with reference to FIG. 1. For example, the central node 130-a may receive an application, for example an application submitted by a third party, and distribute the application to one or more mobile platforms (e.g., mobile platforms 150, mobile platforms 150-a). In some examples, the mobile platforms to which an application is distributed may be selected by a third party developer of the application, or may be determined by the central node 130-a. The central node 130-a may also distribute updates for the application to the one or more mobile platforms. In some cases, the central node 130-a may distribute updates according to an update period for the application. For example, the third party developer of the application may select an update period, such as daily updates, weekly updates, monthly updates, and so on. The third party developer may provide the updates to the central node 130-a, and the central node 130-a may distribute the updates according to the selected update period.

The central node 130-a may include or may support a development environment 135-a. The development environment 135-a may be an example of software used in the development of applications managed by the central node 130-a. For example, the development environment 135-a may be associated with an SDK, which may allow for development of applications to be executed on one or more mobile platforms. In some examples, the development environment 135-a may also include an API, which may be associated with the SDK and may support function calls or requests from applications (e.g., a request which uses a hardware resources of a mobile platform containing a server executing the application). For example, the SDK may include or may facilitate access to one or more libraries used by the API. The central node 130-a may provide the development environment 135-a to third parties, and may receive applications developed using the development environment 135-a.

In some examples, the development environment 135-a may include one or more platform models, such as a platform model 305-a and a platform model 305-b. The platform model 305-a and the platform model 305-b may each be an example of a respective model of server (e.g., a server 162, a server 162-a) on a mobile platform (e.g., a mobile platform 150, a mobile platform 150-a). For example, the platform model 305-a may model a server of a first type of mobile platform (e.g., a model of aircraft, a size of aircraft, an operating system of the server on the aircraft), and the platform model 305-b may model a second type of mobile platform different from the first type.

In some cases, the platform model 305-a may include model resources 310-a of an associated server, and the platform model 305-b may include model resources 310-b of an associated server which may allow a developer using the development environment 135-a to simulate application performance and compatibility (e.g., compatibility with hardware resources of the mobile platform, compatibility with libraries on the server of the mobile platform) using the model resources 310-a or 310-b, or may simulate the application performance using a selected amount of resources. Additionally, the platform model 305-a and the platform model 305-b may include respective models of hardware resources of the associated mobile platforms (e.g., models of various aircraft operational information).

To develop an application, a developer may use a platform model 305 to execute the application using various combinations of libraries and resources. The developer may test the application using the platform model 305 in various simulated scenarios (e.g., the platform model 305 may simulate flight scenarios, or may introduce variance into the model resources 310). The developer may then send the application to the central node 130-a, and the central node 130-a may build the application (e.g., compile code of the application) using one or more libraries, for example libraries associated with the API and SDK.

In some examples, the central node 130-a may certify an application prior to distributing the application. For example, the central node 130-a may determine whether the application based on an identity of a developer of the application (e.g., based on whether the developer is an approved developer), based on a determination of whether the application is secure (e.g., whether the application satisfies one or more security tests), based on performance of the application (e.g., whether the application satisfies one or more performance thresholds), or any combination thereof. For example, if the application makes use of a particular hardware resource, the central node 130-a may determine whether the developer is authorized to access that hardware resource.

If the central node 130-a determines to certify the application, the central node 130-a may distribute the application to one or more mobile platforms, for example over a communication network. Additionally, upon certifying the application, the central node 130-a may transmit an indication to provision containers for the applications to servers of the one or more mobile platforms. Each server may, using a respective containerization engine, allocate resources for the application including providing calls in the container for the application to the hardware resources. In addition, the central node 130-a may compile the application with appropriate libraries for the servers of each mobile platform for which the application is to be distributed. Alternatively, if the central node 130-a determines not to certify the application, the central node 130-a may not distribute the application, and, in some cases, may notify the developer that the application was not certified.

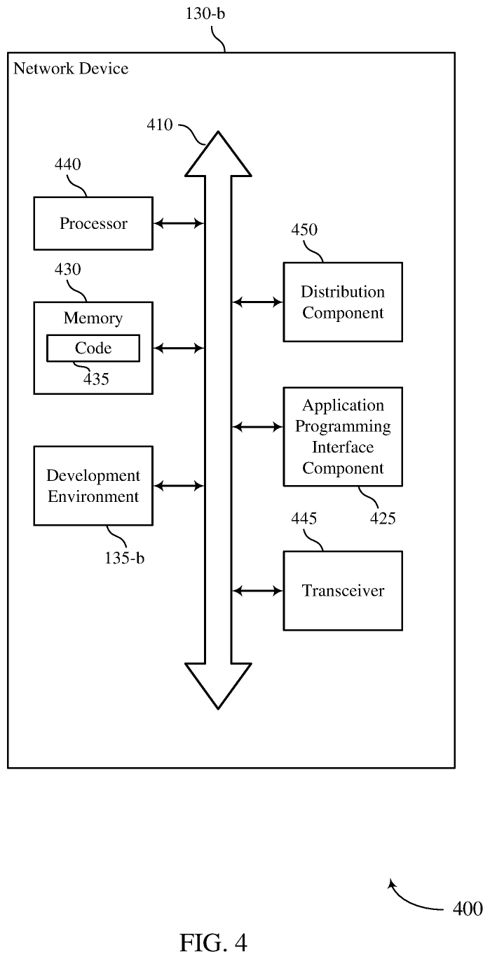

FIG. 4 shows a block diagram 400 of a central node 130-b that supports aircraft server containerization in accordance with aspects of the present disclosure. The central node 130-b may be an example of aspects of a satellite communication system 100, system 200, or system 300 as described with reference to FIGS. 1 through 3. The central node 130-b, or various components thereof, may be an example of means for performing various aspects of aircraft server containerization as described herein. For example, the central node 130-b may include an application programming interface component 425, which may be included in or be an example of aspects of the central node 130 and servers 162, a distribution component 450, which may be an example of the central node 130, the ground-based terminal 110, the satellite 120, the antenna system 152, or any combination thereof, code 435 stored in memory 430, a processor 440, a bus 410, and a transceiver 445. Each of these components may communicate, directly or indirectly, with one another.

The application programming interface component 425 may be configured as or otherwise support a means for providing, on a plurality of mobile platforms comprising respective servers coupled with a communication network, respective containerization engines associated with an application programming interface that comprises at least one supported request associated with a hardware resource of the plurality of mobile platforms. The distribution component 450 may be configured as or otherwise support a means for receiving, at a central node of the communication network, an application associated with the application programming interface. The distribution component 450 may be configured as or otherwise support a means for distributing the application to the respective servers of the subset of the plurality of mobile platforms via the communication network.

In some examples, the distribution component 450 may be configured as or otherwise support a means for receiving, at the central node of the communication network, a second application associated with the application programming interface. In some examples, the distribution component 450 may be configured as or otherwise support a means for distributing the application to the respective servers of the subset of the plurality of mobile platforms via the communication network.

In some examples, the distribution component 450 may be configured as or otherwise support a means for identifying a first update period for the application and a second update period for the second application, the first update period different than the second update period. In some examples, the distribution component 450 may be configured as or otherwise support a means for distributing, via the communication network, a first update for the application based at least in part on the first update period and a second update for the second application based at least in part on the second update period.

In some examples, the distribution component 450 may be configured as or otherwise support a means for determining, at the central node, whether to certify the application for distribution to the respective servers based at least in part on receiving the application, wherein provisioning the respective containers is based at least in part on the determining.

In some examples, the respective sets of resources comprise respective amounts of storage in respective non-volatile memory devices of the respective servers. In some examples, the respective sets of resources comprise respective amounts of data communicated over the communication network. In some examples, the respective sets of resources comprise respective portions of respective capacities of respective central processing units of the respective servers. In some examples, the respective sets of resources comprise access to respective data buses associated with respective operational events of respective mobile platforms of the subset.

In some examples, the development environment 135-b may be configured as or otherwise support a means for providing a development environment for the application programming interface, wherein receiving the application is based at least in part on the development environment. In some examples, the development environment comprises a model of a server corresponding to the respective servers and the hardware resource.

Bus 410 may represent an interface over which signals may be exchanged between components of central node 130-b and a location (e.g., a central location) that may be used to distribute the signals to a signal processing components of central node 130-b (e.g., transceiver 445). Bus 410 may one or more wired interfaces. Additionally, or alternatively, bus 410 may be a wireless interface that is used to wirelessly communicate signaling between the signal processing components—e.g., in accordance with a communication protocol.

The memory 430 may include volatile memory (e.g., RAM) and/or nonvolatile memory (e.g., ROM). Other types of memory may also be possible. The memory 430 may store code 435 that is computer-readable and computer-executable. The code may include instructions that, when executed by the processor 440, cause the central node 130-b to perform various functions described herein. The code 435 may be stored in a non-transitory computer-readable medium such as system memory or another type of memory. In some cases, the code 435 may not be directly executable by the processor 440 but may cause a computer (e.g., when compiled and executed) to perform functions described herein. In some cases, the memory 430 may contain, among other things, a BIOS which may control basic hardware or software operation such as the interaction with peripheral components or devices.

Processor 440 may include an intelligent hardware device (e.g., a general-purpose processor, a DSP, a CPU, a microcontroller, an ASIC, a field programmable gate array (FPGA), an PLD, a discrete gate or transistor logic component, a discrete hardware component, or any combination thereof). The processor 440 may be configured to execute computer-readable instructions stored in a memory (e.g., memory 430) to cause the central node 130-b to perform various functions (e.g., functions or tasks supporting aircraft server containerization). For example, the central node 130-b or a component of the central node 130-b may include a processor 440 and memory 430 coupled to the processor 440 that are configured to perform various functions described herein.

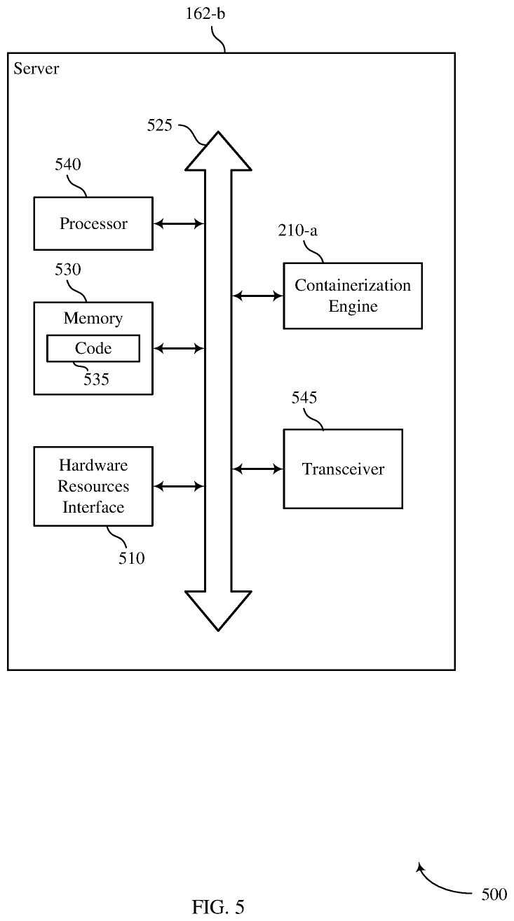

FIG. 5 shows an example of a block diagram 500 of a server 162-b of a mobile platform that supports aircraft server containerization in accordance with aspects of the present disclosure. The server 162-b may be an example of aspects of a satellite communication system 100, system 200, or system 300 as described with reference to FIGS. 1 through 3. The server 162-b, or various components thereof, may be an example of means for performing various aspects of aircraft server containerization as described herein. For example, the server 162-b may include an containerization engine 210-a, hardware resources interface 510, which may include or interface with aspects of the hardware resources 161-a, code 535 stored in memory 530, a processor 540, a bus 525, and a transceiver 545. Each of these components may communicate, directly or indirectly, with one another.

Bus 525 may represent an interface over which signals may be exchanged between components the server 162-b and a location (e.g., a central location) that may be used to distribute the signals to the signal processing components of the server 162-b (e.g., transceiver 545). Bus 525 may one or more wired interfaces. Additionally, or alternatively, bus 525 may be a wireless interface that is used to wirelessly communicate signaling between the signal processing components—e.g., in accordance with a communication protocol.

The memory 530 may include volatile memory (e.g., RAM) and/or nonvolatile memory (e.g., ROM). Other types of memory may also be possible. The memory 530 may store code 535 that is computer-readable and computer-executable. The code may include instructions that, when executed by the processor 540, cause the server 162-b to perform various functions described herein. The code 535 may be stored in a non-transitory computer-readable medium such as system memory or another type of memory. In some cases, the code 535 may not be directly executable by the processor 540 but may cause a computer (e.g., when compiled and executed) to perform functions described herein. In some cases, the memory 530 may contain, among other things, a BIOS which may control basic hardware or software operation such as the interaction with peripheral components or devices.

Processor 540 may include an intelligent hardware device (e.g., a general-purpose processor, a DSP, a CPU, a microcontroller, an ASIC, a field programmable gate array (FPGA), an PLD, a discrete gate or transistor logic component, a discrete hardware component, or any combination thereof). The processor 540 may be configured to execute computer-readable instructions stored in a memory (e.g., memory 530) to cause the server 162-b to perform various functions (e.g., functions or tasks supporting aircraft server containerization). For example, the server 162-b or a component of the server 162-b may include a processor 540 and memory 530 coupled to the processor 540 that are configured to perform various functions described herein.

The central node 130-b may be configured as or otherwise support a means for providing, on the server 162-b, the containerization engine 210-a associated with an application programming interface that comprises at least one supported request associated with a hardware resource of the plurality of mobile platforms. The containerization engine 210-a may be configured as or otherwise support a means for provisioning, on the server 162-b, containers for the application, the containers associated with sets of resources of the server 162-b.

In some examples, the containerization engine 210-a may be configured as or otherwise support a means for provisioning, on the server 162-b, second containers for a second application, the second containers associated with respective second sets of resources of the server 162-b, wherein the second sets of resources comprise at least one resource that is different from the respective first sets of resources. In some examples, the transceiver 545 may be configured as or otherwise support a means for receiving the application via the communication network.

In some examples, the processor 540 may be configured as or otherwise support a means for executing the application on the server 162-b using the sets of resources.

In some examples, the respective sets of resources comprise respective amounts of storage in respective non-volatile memory devices (e.g., memory 530) of the respective servers. In some examples, the respective sets of resources comprise respective amounts of data communicated over the communication network. In some examples, the respective sets of resources comprise respective portions of respective capacities of respective central processing units of the respective servers. In some examples, the respective sets of resources comprise access to respective data buses (e.g., via a hardware resources interface 510) associated with respective operational events of respective mobile platforms of the subset.

In some examples, to support provisioning the respective containers for the application, the containerization engine 210-a may be configured as or otherwise support a means for linking one or more libraries associated with the respective sets of resources of the respective servers.

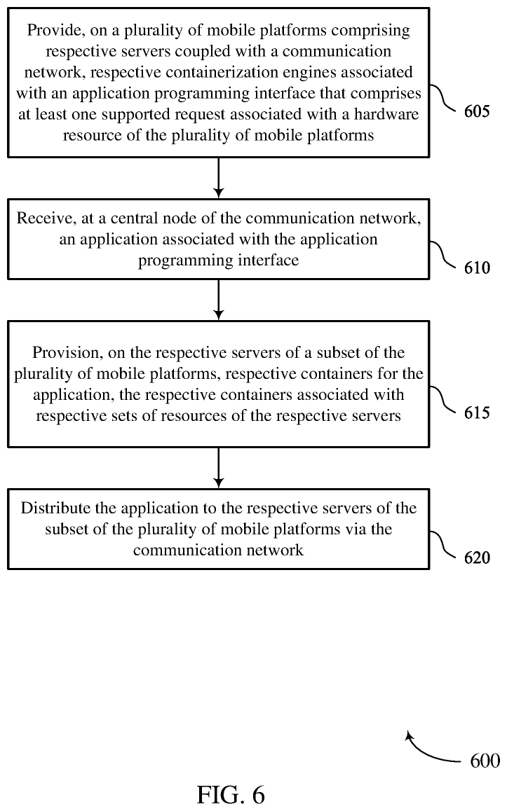

FIG. 6 shows a flowchart illustrating a method 600 that supports aircraft server containerization in accordance with aspects of the present disclosure. The operations of the method 600 may be implemented by a communications network or its components as described herein. For example, the operations of the method 600 may be performed by a communications network as described with reference to FIGS. 1 through 5. In some examples, a communications network may execute a set of instructions to control the functional elements of the communications network to perform the described functions. Additionally, or alternatively, the communications network may perform aspects of the described functions using special-purpose hardware.

At 605, the method may include providing, on a plurality of mobile platforms comprising respective servers coupled with a communication network, respective containerization engines associated with an application programming interface that comprises at least one supported request associated with a hardware resource of the plurality of mobile platforms. The operations of 605 may be performed in accordance with examples as disclosed herein. In some examples, aspects of the operations of 605 may be performed by an application programming interface component 425 as described with reference to FIG. 4.

At 610, the method may include receiving, at a central node of the communication network, an application associated with the application programming interface. The operations of 610 may be performed in accordance with examples as disclosed herein. In some examples, aspects of the operations of 610 may be performed by a transceiver 445 as described with reference to FIG. 4.

At 615, the method may include provisioning, on the respective servers of a subset of the plurality of mobile platforms, respective containers for the application, the respective containers associated with respective sets of resources of the respective servers. The operations of 615 may be performed in accordance with examples as disclosed herein. In some examples, aspects of the operations of 615 may be performed by a containerization engine 210-a as described with reference to FIG. 5.

At 620, the method may include distributing the application to the respective servers of the subset of the plurality of mobile platforms via the communication network. The operations of 620 may be performed in accordance with examples as disclosed herein. In some examples, aspects of the operations of 620 may be performed by a distribution component 450 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer readable media includes both non transitory computer storage media and communication media including any medium that facilitates transfer of a computer program from one place to another. A non-transitory storage medium may be any available medium that can be accessed by a general purpose or special purpose computer. By way of example, and not limitation, non-transitory computer readable media may include RAM, ROM, electrically erasable programmable read-only memory (EEPROM), flash memory, compact disk read-only memory (CDROM) or other optical disk storage, magnetic disk storage or other magnetic storage devices, or any other non-transitory medium that can be used to carry or store desired program code means in the form of instructions or data structures and that can be accessed by a general purpose or special purpose computer, or a general purpose or special purpose processor. Also, any connection is properly termed a computer readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu ray disc where disks usually reproduce data magnetically, while discs reproduce data optically with lasers. Combinations of the above are also included within the scope of computer readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method, comprising:
providing, on a plurality of mobile platforms comprising respective servers coupled with a communication network respective containerization engines associated with an application programming interface that supports at least one request associated with a hardware resource of the plurality of mobile platforms;
receiving, at a central node of the communication network, code of an application, wherein the application programming interface supports requests from the application, the requests including the at least one request associated with the hardware resource of the plurality of mobile platforms;
provisioning, on the respective servers of a subset of the plurality of mobile platforms respective containers for the application, the respective containers associated with respective sets of resources of the respective servers; and
distributing, based at least in part on compiling the code, the application to the respective servers of the subset of the plurality of mobile platforms via the communication network, wherein the respective sets of resources are selected for the respective containers based at least in part on an amount of resources to support the application.

2. The method of claim 1, further comprising:
receiving, at the central node of the communication network, a second application associated with the application programming interface;
provisioning, on the respective servers of the subset of the plurality of mobile platforms, respective second containers for the second application, the respective second containers associated with respective second sets of resources of the respective servers, wherein the respective second sets of resources comprise at least one resource that is different from the respective sets of resources; and
distributing the application to the respective servers of the subset of the plurality of mobile platforms via the communication network.

3. The method of claim 2, further comprising:
identifying a first update period for the application and a second update period for the second application, the first update period different than the second update period; and
distributing, via the communication network, a first update for the application based at least in part on the first update period and a second update for the second application based at least in part on the second update period.

4. The method of claim 1, further comprising:
executing the application on the respective servers of the subset of the plurality of mobile platforms using the respective sets of resources.

5. The method of claim 1, further comprising:
determining, at the central node, whether to certify the application for distribution to the respective servers based at least in part on an identity of a developer of the application, a determination of whether the application is secure, performance of the application, or any combination thereof, wherein provisioning the respective containers is based at least in part on a certification of the application.

6. The method of claim 1, wherein the respective sets of resources comprise respective amounts of storage in respective non-volatile memory devices of the respective servers.

7. The method of claim 1, wherein the respective sets of resources comprise respective amounts of data communicated over the communication network.

8. The method of claim 1, wherein the respective sets of resources comprise respective portions of respective capacities of respective central processing units of the respective servers.

9. The method of claim 1, wherein the respective sets of resources comprise access to respective data buses associated with respective operational events of respective mobile platforms of the subset.

10. The method of claim 1, wherein provisioning the respective containers for the application comprises:
linking one or more libraries with the application, wherein the one or more libraries are associated with the respective sets of resources of the respective servers.

11. The method of claim 1, further comprising:
providing a development environment for the application programming interface, wherein receiving the application is based at least in part on the development environment.

12. The method of claim 11, wherein the development environment comprises a model of a server corresponding to the respective servers and the hardware resource.

13-24. (canceled)

25. An apparatus, comprising: a controller associated with a memory device, wherein the controller is configured to cause the apparatus to:
provide, on a plurality of mobile platforms comprising respective servers coupled with a communication network, respective containerization engines associated with an application programming interface that supports at least one request associated with a hardware resource of the plurality of mobile platforms;
receive, at a central node of the communication network, code of an application, wherein the application programming interface supports requests from the application, the requests including the at least one request associated with the hardware resource of the plurality of mobile platforms;
provision, on the respective servers of a subset of the plurality of mobile platforms, respective containers for the application, the respective containers associated with respective sets of resources of the respective servers; and
distribute, based at least in part on compiling the code, the application to the respective servers of the subset of the plurality of mobile platforms via the communication network, wherein the respective sets of resources are selected for the respective containers based at least in part on an amount of resources to support the application.

26. The apparatus of claim 25, wherein the controller is further configured to cause the apparatus to:
receive, at the central node of the communication network, a second application associated with the application programming interface;
provision, on the respective servers of the subset of the plurality of mobile platforms, respective second containers for the second application, the respective second containers associated with respective second sets of resources of the respective servers, wherein the respective second sets of resources comprise at least one resource that is different from the respective sets of resources; and
distribute the application to the respective servers of the subset of the plurality of mobile platforms via the communication network.

27. The apparatus of claim 26, wherein the controller is further configured to cause the apparatus to:
identify a first update period for the application and a second update period for the second application, the first update period different than the second update period; and
distribute, via the communication network, a first update for the application based at least in part on the first update period and a second update for the second application based at least in part on the second update period.

28. The apparatus of claim 25, wherein the controller is further configured to cause the apparatus to:
execute the application on the respective servers of the subset of the plurality of mobile platforms using the respective sets of resources.

29. The apparatus of claim 25, wherein the controller is further configured to cause the apparatus to:
determine, at the central node, whether to certify the application for distribution to the respective servers based at least in part on an identity of a developer of the application, a determination of whether the application is secure, performance of the application, or any combination thereof, wherein provisioning the respective containers is based at least in part on a certification of the application.

30. The apparatus of claim 25, wherein the respective sets of resources comprise respective amounts of storage in respective non-volatile memory devices of the respective servers.

31. The apparatus of claim 25, wherein the respective sets of resources comprise respective amounts of data communicated over the communication network.

32. The apparatus of claim 25, wherein the respective sets of resources comprise respective portions of respective capacities of respective central processing units of the respective servers.

33. The apparatus of claim 25, wherein the respective sets of resources comprise access to respective data buses associated with respective operational events of respective mobile platforms of the subset.

34. The apparatus of claim 25, wherein provisioning the respective containers for the application is configured to cause the apparatus to:
link one or more libraries with the application, wherein the one or more libraries are associated with the respective sets of resources of the respective servers.

35. The apparatus of claim 25, wherein the controller is further configured to cause the apparatus to:
provide a development environment for the application programming interface, wherein receiving the application is based at least in part on the development environment.

36. The apparatus of claim 35, wherein the development environment comprises a model of a server corresponding to the respective servers and the hardware resource.

37. The method of claim 1, wherein the application supports use of a container having access to a respective data bus associated with respective operational events of each mobile platform of the subset of the plurality of mobile platforms.
